(19) United States
(12) Patent Application Publication
(10) Pub. No.: US 2009/0315998 A1
(43) Pub. Date: Dec. 24, 2009

(54) Self diagnostics of TV

(76) Inventor: Praggya Garg, San Diego, CA (US)

Correspondence Address: MILLER PATENT SERVICES, 2500 DOCKERY LANE, RALEIGH, NC, 27606, US

(21) Appl. No.: 12/214,715

(22) Filed: Jun. 20, 2008

(51) Int. Cl. H04N 17/04; H04N 17/00

(52) U.S. Cl. 348/177; 348/569

(57) ABSTRACT

In accord with certain embodiments consistent with the present invention, a television diagnostic method involves providing a user selectable menu selection on the television display that invokes a diagnostic process; upon a user invoking the diagnostic process, carrying out a plurality of functional tests upon the television set; reading user settings from a memory in the television set; transmitting results from the plurality of tests to a diagnostic center via the Internet; and carrying out an interactive two-way communication with the diagnostic center to resolve any problems identified with the television set. This abstract is not to be considered limiting, since other embodiments may deviate from the features described in this abstract.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

Often television devices are returned to the manufacture or a service center for service, when the problem may be minute or a result of an improper user setting. This problem can be amplified by the complexity of home entertainment systems and the like. As a result of these problems, not only are service facilities often burdened with devices that are not faulty or can be resolved by the consumer, but also telephone calls customer service departments are an increasing financial burden on manufacturers. In many cases, the TV sets are returned due to user correctable problems with set or just simple user settings. Thus, both the user (consumer) and the manufacturer are unnecessarily burdened.

### BRIEF DESCRIPTION OF THE DRAWINGS

Certain illustrative embodiments illustrating organization and method of operation, together with objects and advantages may be best understood by reference detailed description that follows taken in conjunction with the accompanying drawings in which:

FIG. 1 is a flow chart of an exemplary process consistent with certain embodiments of the present invention.

FIG. 2 is another flow chart of an exemplary embodiment consistent with certain embodiments of the present invention.

FIG. 4 is another flow chart of an exemplary embodiment consistent with certain embodiments of the present invention.

FIG. 5 is a flow chart of a basic diagnostic system block diagram of a system consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically. The term “program” or “computer program” or similar terms, as used herein, is defined as a sequence of instructions designed for execution on a computer system. A “program”, or “computer program”, may include a subroutine, a function, a procedure, an object method, an object implementation, in an executable application, an applet, a servlet, a source code, an object code, a shared library/dynamic load library and/or other sequence of instructions designed for execution on a computer system.

The tern “program”, as used herein, may also be used in a second context (the above definition being for the first context). In the second context, the term is used in the sense of a “television program”. In this context, the term is used to mean any coherent sequence of audio video content such as those which would be interpreted as and reported in an electronic program guide (EPG) as a single television program, without regard for whether the content is a movie, sporting event, segment of a multi-part series, news broadcast, etc. The term may also be interpreted to encompass commercial spots and other program-like content which may not be reported as a program in an electronic program guide.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

As noted above, often television (TV) devices are returned to the manufacture or a service center for service, when the problem may be minute or a result of an improper user setting. This problem can be amplified by the complexity of home entertainment systems and the like. As a result of these problems, not only are service facilities often burdened with devices that are not faulty or can be resolved by the consumer, but also telephone calls customer service departments are an increasing financial burden on manufacturers. In many cases, the TV sets are returned due to user correctable problems with set or just simple user settings. Thus, both the user (consumer) and the manufacturer are unnecessarily burdened.

These problems can be ameliorated by a television that performs a self diagnostics thru a menu option (e.g., on a cross-media bar (XMB) menu selection). If the TV finds anything wrong during the self diagnosis, it will display the relevant information on TV. The user then has an option to notify the manufacturer's customer service department thru an Internet based communication system connected to the TV directly without having to make a phone call or wait for the part or TV to completely go bad. By use of two-way communication between TV and customer service, this feature can also be used to troubleshoot some common issues with audio, video and device connection settings as the self diagnostics result screen can also display what settings the user has at that time. When replacement parts are required, they can be ordered to more efficiently expedite the repair process.

In certain embodiments, this will help both the user and the manufacturer in some or all of the following ways (and possibly others): 1) cutting the number of phone calls Customer Service gets; 2) reduce the number of sets being returned as the user will be able to get info on what user settings he has and change them accordingly; and 3) provide the manufacturer with valuable information on how the TV is performing in the field.

In certain preferred embodiments, Sony Corporation's Bravia® Internet Video Link (BIVL) diagnostic system is utilized to carry out diagnostics in accord with certain embodiments, but other diagnostic systems can also be used in general.

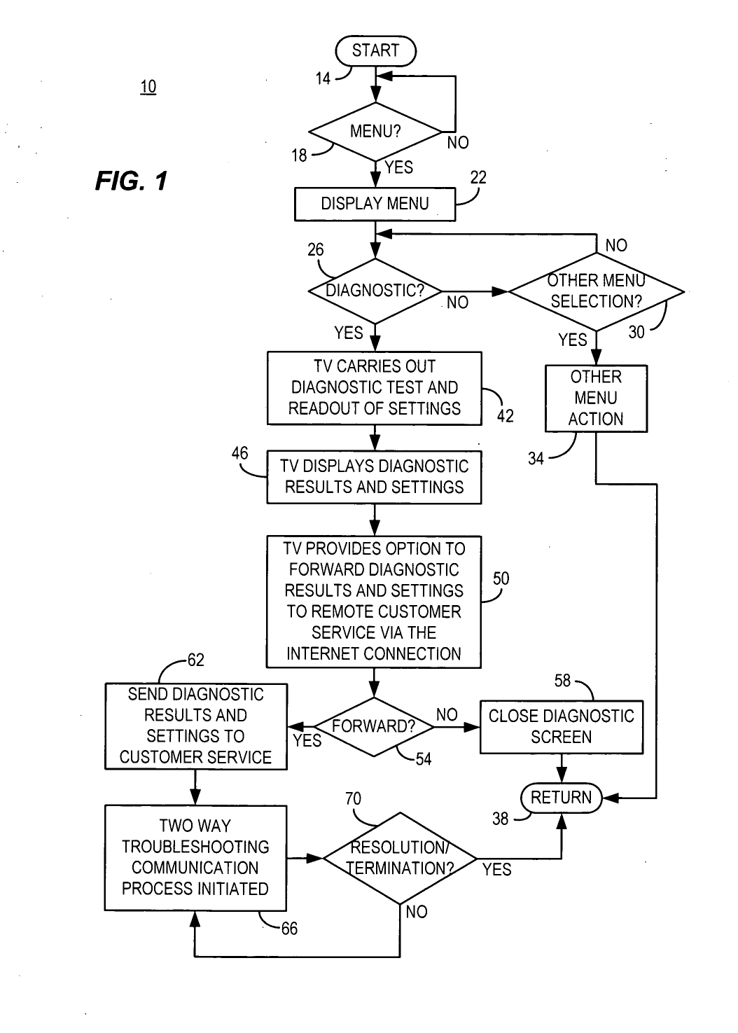

Turning now to FIG. 1, an exemplary process consistent with certain embodiments is depicted as process 10 starting at 14 where a television system awaits user commands (typically, but not necessarily via a remote controller). If the user issues a command to enter a control menu system such as a cross-media bar menu system or any other suitable control system at 18, then a menu is displayed on the television display at 22 which the user can utilize to access various menu controlled functions including, but not limited to, diagnostics, video settings, source settings, channel setup, etc.

The user can then make a selection via the menu for any of several functions or categories of functions by using conventional or known menu navigation techniques. In accord with the present embodiments, we are primarily concerned with making the selection at 26 of a diagnostic function, but other functions, represented as 30 can also be made if diagnostics are not selected. If other menu selections are made at 30, their corresponding actions are carried out at 34 and the process returns at 38 to the start to await another menu activation (or other remote controller command not shown).

If diagnostics is selected from the menu at 26, the television set enters a diagnostic mode at 42 where any number of diagnostic tests can be carried out to determine if there is a hardware or software/firmware failure or marginal component, and to determine the television's current configuration settings (as would be commonly stored in a memory of the television set). The diagnostic system of the television then displays the diagnostic results at 46 on the television screen at 50 provides an option to send the diagnostic results to a remote customer service center via an Internet connection provided in the television set. The user can, in this embodiment, elect to forward the information or not at 54. If the user elects not to send the information, the diagnostic screen is closed at 58 and the process returns at 38.

Any of a number of tests can be carried out in accord with example embodiments consistent with the invention. For example, in one embodiment, tests can be performed to confirm the software version (Front end, Back end, TV micro (i.e., the television's control processor), etc.). This will enable a Customer Service organization to verify the versions and if any upgrades need to be made to resolve any quality (e.g., Video/Audio) issues.

However, if the user chooses to forward the diagnostic and configuration information to the customer service facility at 54, the diagnostic results and configuration information, which may include channel information, inputs selected, software/firmware versions and any other information, are forwarded to the customer service facility at 62. When this information is received, a two way troubleshooting process is initiated at 66 if there is a problem. This process can be handled by an automated diagnostic engine that walks the user through a sequence of steps that will enable further troubleshooting to occur, or may be at any point turned over to a customer support person who can provide additional service in a chat-like manner. This can result in a requirement that the user have service personnel dispatched to fix the problem, or can result in automated order of necessary parts so that a service technician can be better prepared when dispatched. If the problem is resolved, at 70 (or otherwise terminated with dispatch of service personnel or instructions to bring the television to a service facility), the process returns to 38.

In any event, by virtue of sending the configuration and diagnostics results at 62 to a service facility, the diagnostic and setting information can be stored so that the service history and problems can be accumulated in a database where patterns of problems can be identified and potentially rectified either by preemptive software updates or by correction of product defects in future products.

The diagnostic two-way communication of 66 is carried out either with an automated knowledge based troubleshooting routine, or in extreme cases with a human customer service representative via a chat-like dialog carried out using the television to display the dialog. The user can respond by use of entries from the remote control for the television set by selecting from a number of answers or by direct entry of text by a virtual keyboard or by direct remote control entry of answers using text entry.

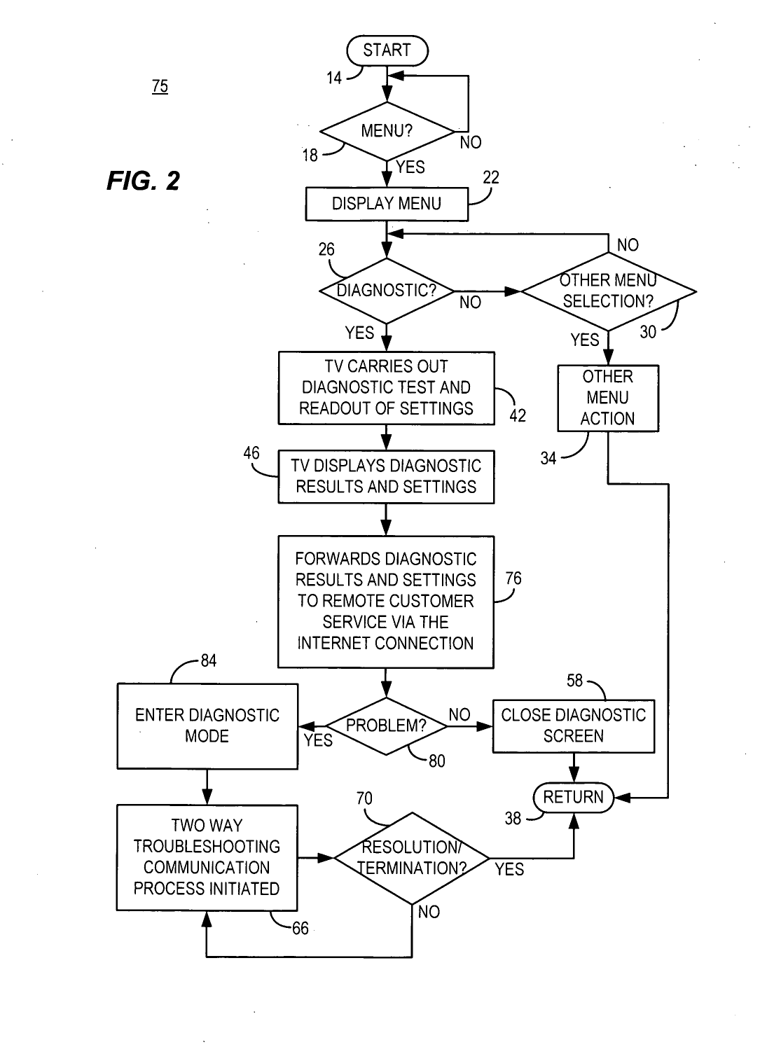

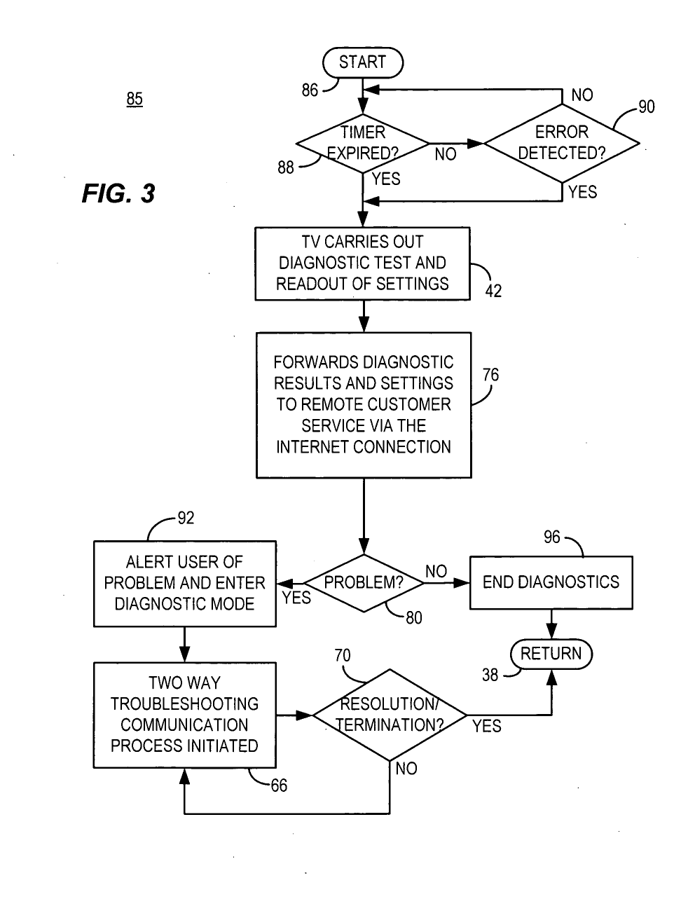

FIG. 2 presents a minor variant of the above process designate 75 in which all diagnostic results are sent to the customer service facility to assist in identifying patterns of problems and improve product quality. In this embodiment, the process flows in a manner similar to that of FIG. 1, except that after the television carries out diagnostic tests at 42, the diagnostic results and settings are automatically forwarded to the customer service facility at 76 in order to provide greater input to the diagnostic database even if no problem is found. However, if a problem is identified at 80, the diagnostic process enters diagnostic mode at 84 and initiates the two-way troubleshooting communication process at 66 as in process 10.

In another embodiment, the diagnostics can be spontaneously initiated as depicted in FIG. 3 as process 85 starting at 86. In this example, on a periodic basis as with a timer at 88, or upon detection of an error at 90 or at an opportune time when the television set is inactive (not shown) the television may self initiate a diagnostic process at 42 as previously. These results are then forwarded along with settings and the like to the customer service facility via the Internet at 76. If a problem has been detected at 80, the user can be alerted at 92 when the television set is activated again, or can be powered up to provide an alert on screen for the user to note next time he observes the television set. Two-way trouble shooting can be initiated at 66 as before. If no problem is detected, the diagnostic routine is closed out at 96 and the process returns at 38.

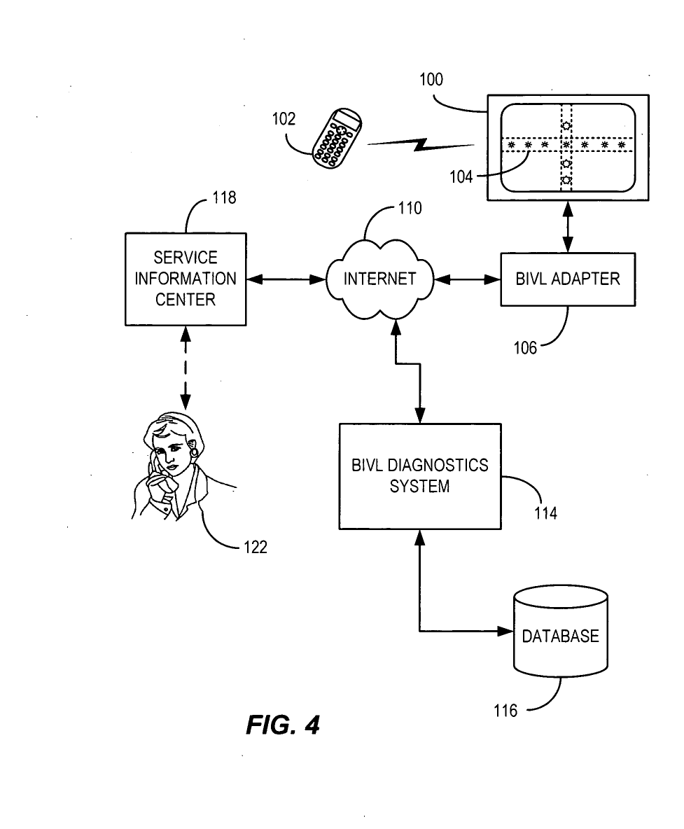

With reference to FIG. 4, an overview of the diagnostic mechanism is depicted in block diagram form where a television set 100 is controlled by use of a remote controller 102 to activate a menu system 1 04, such as a cross media bar menu system (generic icons shown for ease of illustration) or other system. In the preferred embodiment, the television set 100 is connected via a BIVL adapter 1-6or other Internet diagnostic system adapter to the Internet 110 which communicates the diagnostic and configuration information to a BIVL or other diagnostic system 114 incorporating the database 116 previously discussed. The BIVL diagnostic system may incorporate a knowledge based diagnostic process operating under programmed processor control to diagnose the data received from the television set 100. The BIVL diagnostic system 116 may also link the user to a service information center 118 via the Internet so that issues that cannot be handled directly by automated customer service can be handled by a customer support representative 122, including but not limited to providing for dispatch of service personnel or requesting a product return to a local authorized service center.

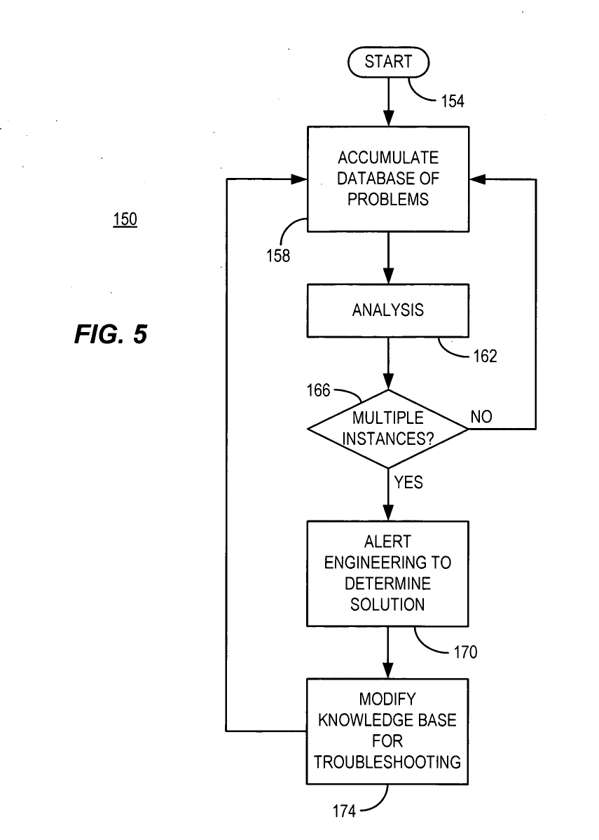

FIG. 5 depicts the basic diagnostic process 150 starting at 154. In this process, each time a diagnostic message is sent from a television to the diagnostic system 114, the data are accumulated in database 116. This facilitates analysis of the data in the database at 162 and presentation of knowledge based solutions to the customer. Statistics from such analysis can be used to identify recurrent problems. When a pattern of multiple instances of the same problem are recognized at 166, and when there is no known solution to the problem cataloged in the database 116, an alert to engineering can be produced so that the engineers can attempt to determine if a general solution can be applied or if a product flaw has been identified. In any case, a solution can be produced and the knowledge base can be modified to account for the problem in the troubleshooting process. Many variants on these processes will occur to those skilled in the art upon consideration of the present teachings.

Thus, in accord with certain embodiments consistent with the present invention, a television diagnostic method involves providing a user selectable menu selection on the television display that invokes a diagnostic process; upon a user invoking the diagnostic process, carrying out a plurality of functional tests upon the television set; reading user settings from a memory in the television set; transmitting results from the plurality of tests to a diagnostic center via the Internet; and carrying out an interactive two-way communication with the diagnostic center to resolve any problems identified with the television set.

In certain embodiments, the results from the plurality of tests and the user settings are stored in a database at the diagnostic center. In certain embodiments, the interactive two-way communication is with an automated diagnostic system operating in conjunction with a knowledge base via a chat-like dialog carried out using the television to display the dialog. In certain embodiments, the interactive two-way communication with the automated diagnostic system operating in conjunction with a knowledge base fails to resolve the problem identified, and further comprising an interactive two-way communication with a customer service representative via a chat-like dialog carried out using the television to display the dialog In certain embodiments, the user selectable menu comprises a cross media bar style menu. In certain embodiments, the knowledge base is updated with diagnostic data resulting from the two-way communication. In certain embodiments, a statistical analysis of the data in the knowledge base is carried out to identify recurrent problems. In certain embodiments, the plurality of functional tests comprise confirming a software version. In certain embodiments, confirming the software version is carried out for the television device's front end, back end, television control processor.

A television diagnostic method according to another example embodiment involves providing a user selectable menu selection from a cross media style menu bar displayed on the television display that invokes a diagnostic process; upon the user invoking the diagnostic process, carrying out a plurality of functional tests upon the television set; reading user settings from a memory in the television set; transmitting results from the plurality of tests to a diagnostic center via the Internet; carrying out an interactive two-way communication with the diagnostic center to resolve any problems identified with the television set; and storing the results from the plurality of tests and the user settings in a database at the diagnostic center; wherein the interactive two-way communication is with an automated diagnostic system operating in conjunction with a knowledge base via a chat-like dialog carried out using the television to display the dialog; and updating the knowledge base with diagnostic data resulting from the two-way communication.

In certain embodiments, the interactive two-way communication with the automated diagnostic system operating in conjunction with a knowledge base fails to resolve the problem identified, and further comprising an interactive two-way communication with a customer service representative via a chat-like dialog carried out using the television to display the dialog. In certain embodiments, a statistical analysis of the data in the knowledge base is carried out to identify recurrent problems. In certain embodiments, the plurality of functional tests comprise confirming a software version. In certain embodiments, the confirming the software version is carried out for the television device's front end, back end, television control processor.

In another example embodiment, a television diagnostic method involves providing a user selectable menu selection from a cross media style menu bar displayed on the television display that invokes a diagnostic process; upon the user invoking the diagnostic process, carrying out a plurality of functional tests upon the television set, wherein the plurality-of functional tests comprise confirming a software version; reading user settings from a memory in the television set; transmitting results from the plurality of tests to a diagnostic center via the Internet; carrying out an interactive two-way communication with the diagnostic center to resolve any problems identified with the television set; and storing the results from the plurality of tests and the user settings in a database at the diagnostic center; wherein the interactive two-way communication is with an automated diagnostic system operating in conjunction with a knowledge base via a chat-like dialog carried out using the television to display the dialog, and wherein the interactive two-way communication with the automated diagnostic system operating in conjunction with a knowledge base fails to resolve the problem identified, and further comprising an interactive two-way communication with a customer service representative via a chat-like dialog carried out using the television to display the dialog; carrying out a statistical analysis of the data in the knowledge base to identify recurrent problems; and updating the knowledge base with diagnostic data resulting from the two-way communication.

In certain embodiments, the confirming the software version is carried out for the television device's front end, back end, television control processor. Any of the above processes can be carried out using an electronic storage medium storing instructions that when executed on a programmed processor carry out the method.

Those skilled in the art will recognize, upon consideration of the above teachings, that certain of the above exemplary embodiments are based upon use of a programmed processor. However, the invention is not limited to such exemplary embodiments, since other embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

While certain embodiments herein were described in conjunction with specific circuitry that carries out the functions described, other embodiments are contemplated in which the circuit functions are carried out using equivalent executed on one or more programmed processors. General purpose computers, microprocessor based computers, micro-controllers, optical computers, analog computers, dedicated processors, application specific circuits and/or dedicated hard wired logic and analog circuitry may be used to construct alternative equivalent embodiments. Other embodiments could be implemented using hardware component equivalents such as special purpose hardware and/or dedicated processors.

Certain embodiments may be implemented using a programmed processor executing programming instructions that in certain instances are broadly described above in flow chart form that can be stored on any suitable electronic or computer readable storage medium (such as, for example, disc storage, Read Only Memory (ROM) devices, Random Access Memory (RAM) devices, network memory devices, optical storage elements, magnetic storage elements, magneto-optical storage elements, flash memory, core memory and/or other equivalent volatile and non-volatile storage technologies) and/or can be transmitted over any suitable electronic communication medium. However, those skilled in the art will appreciate, upon consideration of the present teaching, that the processes described above can be implemented in any number of variations and in many suitable programming languages without departing from embodiments of the present invention. For example, the order of certain operations carried out can often be varied, additional operations can be added or operations can be deleted without departing from certain embodiments of the invention. Error trapping can be added and/or enhanced and variations can be made in user interface and information presentation without departing from certain embodiments of the present invention. Such variations are contemplated and considered equivalent.

While certain illustrative embodiments have been described, it is evident that many alternatives, modifications, permutations and variations will become apparent to those skilled in the art in light of the foregoing description.

What is claimed is:

1. A television diagnostic method, comprising:
providing a user selectable menu selection on the television display that invokes a diagnostic process;
upon the user invoking the diagnostic process, carrying out a plurality of functional tests upon the television set;
reading user settings from a memory in the television set;
transmitting results from the plurality of tests to a diagnostic center via the Internet; and
carrying out an interactive two-way communication with the diagnostic center to resolve any problems identified with the television set.

2. The method according to claim 1, wherein the results from the plurality of tests and the user settings are stored in a database at the diagnostic center.

3. The method according to claim 1, wherein the interactive two-way communication is with an automated diagnostic system operating in conjunction with a knowledge base via a chat-like dialog carried out using the television to display the dialog.

4. The method according to claim 3, wherein the interactive two-way communication with the automated diagnostic system operating in conjunction with a knowledge base fails to resolve the problem identified, and further comprising an interactive two-way communication with a customer service representative via a chat-like dialog carried out using the television to display the dialog.

5. The method according to claim 3, wherein the user selectable menu comprises a cross media bar style menu.

6. The method according to claim 3, further comprising updating the knowledge base with diagnostic data resulting from the two-way communication.

7. The method according to claim 6, further comprising carrying out a statistical analysis of the data in the knowledge base to identify recurrent problems.

8. The method according to claim 1, wherein the user selectable menu comprises a cross media bar style menu.

9. The method according to claim 1, wherein the plurality of functional tests comprise confirming a software version.

10. The method according to claim 9, wherein the confirming the software version is carried out for the television device's front end, back end, television control processor.

11. An electronic storage medium storing instructions that when executed on a programmed processor carry out the method according to claim 1.

12. A television diagnostic method, comprising:
providing a user selectable menu selection from a cross media style menu bar displayed on the television display that invokes a diagnostic process;
upon the user invoking the diagnostic process, carrying out a plurality of functional tests upon the television set;
reading user settings from a memory in the television set;
transmitting results from the plurality of tests to a diagnostic center via the Internet;
carrying out an interactive two-way communication with the diagnostic center to resolve any problems identified with the television set; and
storing the results from the plurality of tests and the user settings in a database at the diagnostic center;
wherein the interactive two-way communication is with an automated diagnostic system operating in conjunction with a knowledge base via a chat-like dialog carried out using the television to display the dialog; and
updating the knowledge base with diagnostic data resulting from the two-way communication.

13. The method according to claim 12, wherein the interactive two-way communication with the automated diagnostic system operating in conjunction with a knowledge base fails to resolve the problem identified, and further comprising an interactive two-way communication with a customer service representative via a chat-like dialog carried out using the television to display the dialog.

14. The method according to claim 12, further comprising carrying out a statistical analysis of the data in the knowledge base to identify recurrent problems.

15. The method according to claim 1, wherein the plurality of functional tests comprise confirming a software version.

16. The method according to claim 15, wherein the confirming the software version is carried out for the television device's front end, back end, television control processor.

17. An electronic storage medium storing instructions that when executed on a programmed processor carry out the method according to claim 12.

18. A television diagnostic method, comprising:
providing a user selectable menu selection from a cross media style menu bar displayed on the television display that invokes a diagnostic process;
upon the user invoking the diagnostic process, carrying out a plurality of functional tests upon the television set, wherein the plurality of functional tests comprise confirming a software version;
reading user settings from a memory in the television set;
transmitting results from the plurality of tests to a diagnostic center via the Internet;
carrying out an interactive two-way communication with the diagnostic center to resolve any problems identified with the television set;
storing the results from the plurality of tests and the user settings in a database at the diagnostic center;
wherein the interactive two-way communication is with an automated diagnostic system operating in conjunction with a knowledge base via a chat-like dialog carried out using the television to display the dialog, and wherein the interactive two-way communication with the automated diagnostic system operating in conjunction with a knowledge base fails to resolve the problem identified, and further comprising an interactive two-way communication with a customer service representative via a chat-like dialog carried out using the television to display the dialog;
carrying out a statistical analysis of the data in the knowledge base to identify recurrent problems; and
updating the knowledge base with diagnostic data resulting from the two-way communication.

19. The method according to claim 18, wherein the confirming the software version is carried out for the television device's front end, back end, television control processor.

20. An electronic storage medium storing instructions that when executed on a programmed processor carry out the method according to claim 18.
